(19) United States
(12) Patent Application Publication
(10) Pub. No.: US 2022/0097488 A1
(43) Pub. Date: Mar. 31, 2022

(54) METHOD OF MANUFACTURING AN AIR CONDITIONING REGISTER VANE

(71) Applicant: Ford Global Technologies, LLC, Dearborn, MI (US)

(72) Inventors: John Robert Tresh, Ypsilanti, MI (US); Steven Nicholas Fidh, Ann Arbor, MI (US)

(73) Assignee: Ford Global Technologies, LLC, Dearborn, MI (US)

(21) Appl. No.: 17/039,423

(22) Filed: Sep. 30, 2020

(51) Int. Cl. B60H 1/34; B29C 45/16

(52) U.S. Cl. CPC B60H 1/34; B29K 2309/08; B29C 45/16

(57) ABSTRACT

A method of manufacturing a vane assembly for an air vent includes comprising molding an intermediate member in a molding die, the intermediate member having a head portion and a stem portion extending distally from the head portion, the stem portion defining a gate for the molding, the intermediate member being an unreinforced polymer material, subsequently molding a vane body over the stem portion of the intermediate member in the molding die, the vane body being a reinforced polymer material, and after molding the vane body over the stem portion of the intermediate member, securing a facia to the head portion of the intermediate member to form the vane assembly.

### FIELD

The present disclosure relates to molding processes, and more particularly to molding processes for the manufacture of air register vanes in automotive interiors.

### BACKGROUND

The statements in this section merely provide background information related to the present disclosure and may not constitute prior art.

Automotive interiors have become increasingly more stylish and unique in recent years, as automotive manufacturers seek to appeal to more discerning customers. In one example, specific surfaces in automotive interiors are treated with overlays or trim pieces of a variety of materials (or faux materials), including wood grain, brushed aluminum, carbon fiber, or chrome, among others. Surfaces that have been popular to treat are air register vanes, and more specifically, edges of these air register vanes.

However, attaching overlays to underlying surfaces can be a challenge when different materials are being used. Proper adhesion, in order to achieve both surface finish and long-term durability, can be difficult with a wide variety of materials and underlying part fabrication processes. As a result, the selection of materials for both the underlying component and the overlay is limited, thus limiting design flexibility for automotive interior designers.

These issues related to the use of different materials in overlays for automotive materials, among other issues related to manufacturing such overlays, are addressed by the present disclosure.

### SUMMARY

This section provides a general summary of the disclosure and is not a comprehensive disclosure of its full scope or all of its features.

In one form, a method of manufacturing a vane assembly for an air vent is provided that includes molding an intermediate member in a molding die, the intermediate member comprising a head portion and a stem portion extending distally from the head portion, the stem portion defining a gate for the molding, the intermediate member consisting of an unreinforced polymer material. Subsequently, a vane body is molded over the stem portion of the intermediate member in the molding die, the vane body comprising a reinforced polymer material. After molding the vane body over the stem portion of the intermediate member, a facia is secured to the head portion of the intermediate member to form the vane assembly.

In variations of this method, which may be employed separately or in any combination: the vane body is reinforced with glass fibers; the facia comprises a layered film comprising an adhesive layer, a polymer layer adjacent to the adhesive layer, a metal flake layer adjacent to the polymer layer, and a protective layer adjacent to the metal flake layer, wherein the adhesive layer is secured to the head portion of the intermediate member; at least one of the vane body and the intermediate member comprises at least one mechanical interlock configured to secure the vane body to the intermediate member; the mechanical interlock comprises a tab and a groove; the stem portion of the intermediate member defines a tapered profile; the facia covers a portion of the head portion; the facia covers an entirety of the head portion; and the vane body is molecularly bonded to the intermediate member after the subsequent molding.

In another form, a vane assembly for an air vent is manufactured according to a method of: molding an intermediate member in a molding die, the intermediate member comprising a head portion and a stem portion extending distally from the head portion, the stem portion defining a gate for the molding; subsequently molding a vane body over the stem portion of the intermediate member in the molding die; and after molding the vane body over the stem portion of the intermediate member, securing a facia to the head portion of the intermediate member to form the vane assembly, wherein the vane body is molecularly bonded to the intermediate member after the subsequent molding.

In variations of this vane assembly, which may be employed individually or in any combination: the vane body is reinforced with glass fibers; the intermediate member consists of an unreinforced polymer material; the facia comprises a layered film comprising an adhesive layer, a polymer layer adjacent to the adhesive layer, a metal flake layer adjacent to the polymer layer, and a protective layer adjacent to the metal flake layer, wherein the adhesive layer is secured to the head portion of the intermediate member; the facia covers a portion of the head portion; the facia covers an entirety of the head portion.

In still another form of the present disclosure, a vane assembly for an air vent is manufactured according to a method of: molding an intermediate member in a molding die, the intermediate member comprising a head portion and a stem portion extending distally from the head portion, the stem portion defining a gate for the molding, the intermediate member consisting of an unreinforced polymer material; subsequently molding a vane body over the stem portion of the intermediate member in the molding die, the vane body comprising a reinforced polymer material; and after molding the vane body over the stem portion of the intermediate member, securing a facia to the head portion of the intermediate member to form the vane assembly.

In variations of this vane assembly, which may be employed individually or in any combination: at least one of the vane body and the intermediate member comprises at least one mechanical interlock configured to secure the vane body to the intermediate member; the mechanical interlock comprises a tab and a groove; the facia covers a portion of the head portion; and the facia covers an entirety of the head portion.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is an exploded perspective view of a vane assembly for an air vent constructed according to the teachings of the present disclosure;

FIG. 2 is a perspective cross-sectional view of the assembled vane assembly of FIG. 1;

FIG. 3 is a side view of an intermediate member positioned in a mold and constructed according to the teachings of the present disclosure;

FIG. 4 is an enlarged partial cross-sectional view, taken from detail 4 of FIG. 3, illustrating an interface between the intermediate member and the facia constructed in accordance with the teachings of the present disclosure;

FIG. 5 is a side view of the intermediate member and a vane body positioned in the mold according to the teachings of the present disclosure;

FIG. 6 is an enlarged side view, taken from detail 6 of FIG. 5, illustrating an interface between the intermediate member and the vane body in the mold according to the teachings of the present disclosure; and

FIG. 7 is a side view of an alternative form of a facia constructed according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

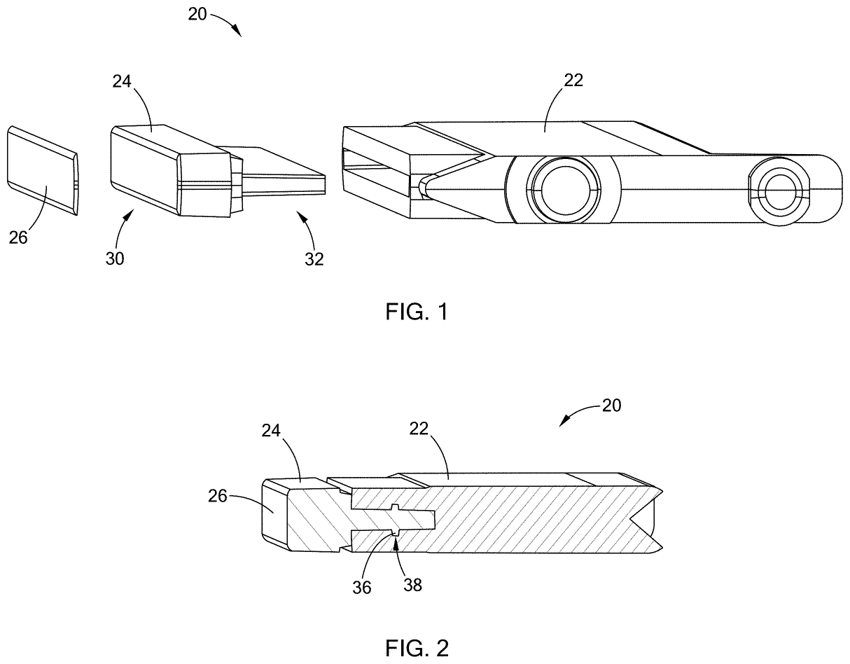

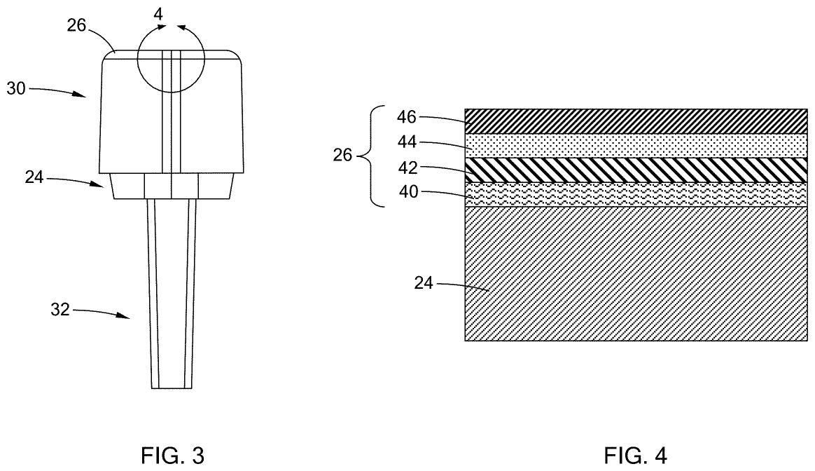

Referring to FIGS. 1 and 2, a vane assembly for an air vent, for example as used in automotive vehicle interiors, is illustrated and generally indicated by reference numeral 20. The vane assembly 20 generally comprises a vane body 22, an intermediate member 24, and a facia 26. The vane body 22 is generally a fiber reinforced polymer material in order to provide specified stiffness requirements, and in one form is reinforced with glass fibers. The facia 26 is generally a layered film material, and because layered film materials are difficult to bond or adhere to fiber reinforced polymers, the intermediate member 24 advantageously consists of an unreinforced polymer material. The unreinforced polymer material may be a nylon, Acrylonitrile Butadiene Styrene (ABS), or Polycarbonate/Acrylonitrile Butadiene Styrene (PCABS), however, it should be understood that other types of thermoplastic polymers may be employed while remaining within the scope of the present disclosure. Further, the vane body 22 in one form is a Polybutylene Terephthalate (PBT) with glass fiber reinforcements (approximately 55% glass fibers in one form). In another form, the vane body 22 is a Polypropylene (PP) with 60% long glass fibers.

The intermediate member 24 comprises a head portion 30 and a stem portion 32 extending distally from the head portion 30. The stem portion 32 is received by the vane body 22, and more specifically within the slot 34. Accordingly, both the stem portion 32 and the slot 34 have a tapered as shown for both molding purposes as described in greater detail below and to better secure the intermediate member 24 to the vane body 22 after molding. If the materials/polymers for each of the intermediate member 24 and vane body 22 are not compatible enough to form a molecular bond during molding, to further improve the mechanical connection between the intermediate member 24 and vane body 22 after molding, locking features may be employed, such as by way of example, a tab 36 and a groove 38. While the tab 36 is shown on the intermediate member 24 and the groove 38 is shown on the vane body 22, it should be understood that the tab 36 and groove 38 may be disposed on one or the other of the intermediate member 24 and vane body 22 while remaining within the scope of the present disclosure. In another form, the intermediate member 24 and vane body 22 are secured together via friction from the molding process and may include surface texturing, or a grain to their surfaces, in order to increase the strength of the interface.

Referring to FIGS. 3 and 4, the facia 26 is secured to the head portion 30 of the intermediate member 24 after molding, which is described in greater detail below. The facia 26 in one form is a layered film and generally includes an adhesive layer 40, a polymer layer 42 adjacent to the adhesive layer 40, a metal flake layer 44 adjacent to the polymer layer 42, and a protective layer 46 adjacent to the metal flake layer 44, wherein the adhesive layer 40 is secured to the head portion 30 of the intermediate member 24. As shown, the facia 26 covers an entirety of the head portion 30, however, it should be understood that the facia 26 may only cover a portion of the head portion 30 while remaining within the scope of the present disclosure.

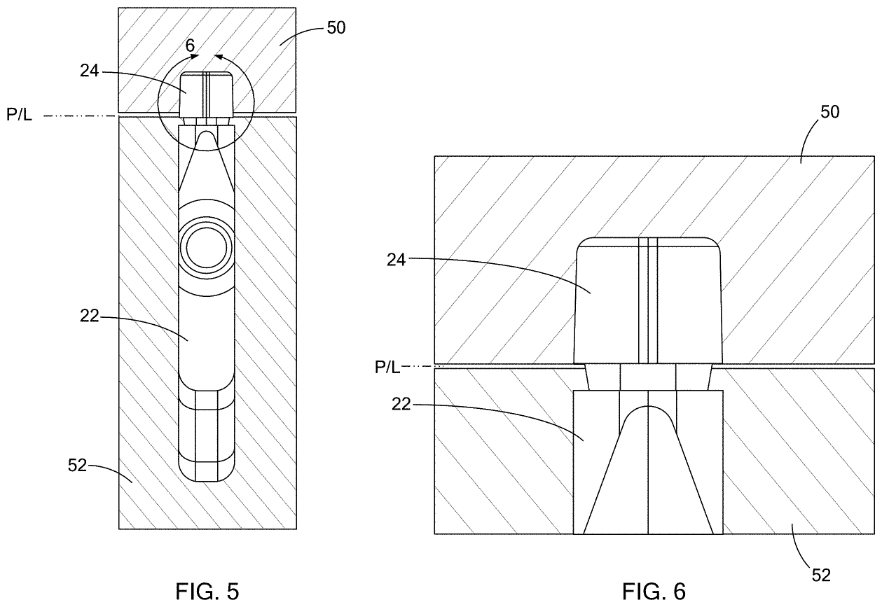

Referring now to FIGS. 5 and 6, the vane assembly 20 is molded by first molding the intermediate member 24 in a molding die comprising upper half 50 and lower half 52. The stem portion 32 defines a gate for the molding, and in this form, the upper half 50 is moving and the lower half is stationary relative to the parting line (P/L as shown). However, it should be understood that a variety of molding die configurations and movements may be employed while remaining within the scope of the present disclosure.

After the intermediate member 24 is molded, a second “shot” is made in the same mold and subsequently molding the vane body 22 over the stem portion of 32 the intermediate member in 24 the molding die. Because the vane body 22 is molded with the intermediate member 24 in the same molding die, while the materials of both parts are heated and generally at or past their glass transition temperature, the vane body 22 is molecularly bonded to the intermediate member 24 after the subsequent molding. After molding the vane body 22 over the stem portion 32 of the intermediate member 24, the facia 26 is secured to the head portion 30 of the intermediate member 24 to form the vane assembly 20. As set forth above, the facia 26 includes an adhesive layer 40, which provides a bonding interface between the intermediate member 24 and the facia 26.

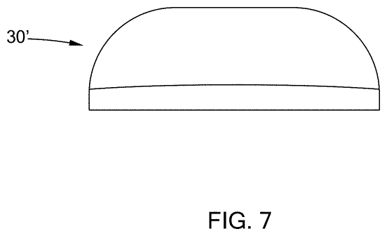

Referring to FIG. 7, because of the flexible manufacturing method of the present disclosure, different shapes or contours for the interior components are available to designers. In this form, head portion 30′ has a more curved and deeper contour. It should be understood that this configuration for the intermediate member 24 is merely exemplary and that a variety of shapes and sizes may be employed while remaining within the scope of the present disclosure.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of manufacturing a vane assembly for an air vent, the method comprising:
molding an intermediate member in a molding die, the intermediate member comprising a head portion and a stem portion extending distally from the head portion, the stem portion defining a gate for the molding, the intermediate member consisting of an unreinforced polymer material;
subsequently molding a vane body over the stem portion of the intermediate member in the molding die, the vane body comprising a reinforced polymer material; and
after molding the vane body over the stem portion of the intermediate member, securing a facia to the head portion of the intermediate member to form the vane assembly.

2. The method according to claim 1, wherein the vane body is reinforced with glass fibers.

3. The method according to claim 1, wherein the facia comprises a layered film comprising an adhesive layer, a polymer layer adjacent to the adhesive layer, a metal flake layer adjacent to the polymer layer, and a protective layer adjacent to the metal flake layer, wherein the adhesive layer is secured to the head portion of the intermediate member.

4. The method according to claim 1, wherein at least one of the vane body and the intermediate member comprises at least one mechanical interlock configured to secure the vane body to the intermediate member.

5. The method according to claim 4, wherein the mechanical interlock comprises a tab and a groove.

6. The method according to claim 1, wherein the stem portion of the intermediate member defines a tapered profile.

7. The method according to claim 1, wherein the facia covers a portion of the head portion.

8. The method according to claim 1, wherein the facia covers an entirety of the head portion.

9. The method according to claim 1, wherein the vane body is molecularly bonded to the intermediate member after the subsequent molding.

10. A vane assembly for an air vent manufactured according to a method of:
molding an intermediate member in a molding die, the intermediate member comprising a head portion and a stem portion extending distally from the head portion, the stem portion defining a gate for the molding;
subsequently molding a vane body over the stem portion of the intermediate member in the molding die; and
after molding the vane body over the stem portion of the intermediate member, securing a facia to the head portion of the intermediate member to form the vane assembly,
wherein the vane body is molecularly bonded to the intermediate member after the subsequent molding.

11. The vane assembly according to claim 10, wherein the vane body is reinforced with glass fibers.

12. The vane assembly according to claim 10, wherein the intermediate member consists of an unreinforced polymer material.

13. The vane assembly according to claim 10, wherein the facia comprises a layered film comprising an adhesive layer, a polymer layer adjacent to the adhesive layer, a metal flake layer adjacent to the polymer layer, and a protective layer adjacent to the metal flake layer, wherein the adhesive layer is secured to the head portion of the intermediate member.

14. The vane assembly according to claim 10, wherein the facia covers a portion of the head portion.

15. The vane assembly according to claim 10, wherein the facia covers an entirety of the head portion.

16. A vane assembly for an air vent manufactured according to a method of:
molding an intermediate member in a molding die, the intermediate member comprising a head portion and a stem portion extending distally from the head portion, the stem portion defining a gate for the molding, the intermediate member consisting of an unreinforced polymer material;
subsequently molding a vane body over the stem portion of the intermediate member in the molding die, the vane body comprising a reinforced polymer material; and
after molding the vane body over the stem portion of the intermediate member, securing a facia to the head portion of the intermediate member to form the vane assembly.

17. The vane assembly according to claim 16, wherein at least one of the vane body and the intermediate member comprises at least one mechanical interlock configured to secure the vane body to the intermediate member.

18. The vane assembly according to claim 17, wherein the mechanical interlock comprises a tab and a groove.

19. The vane assembly according to claim 17, wherein the facia covers a portion of the head portion.

20. The vane assembly according to claim 17, wherein the facia covers an entirety of the head portion.
